(19) United States
(12) Patent Application Publication
(10) Pub. No.: US 2026/0285718 A1
(43) Pub. Date: Sep. 24, 2026

(54) WATER TREATMENT DEVICE AND WATER TREATMENT METHOD

(71) Applicant: ORGANO CORPORATION, Tokyo (JP)

(72) Inventor: Tsukasa KONDO, Tokyo (JP)

(73) Assignee: ORGANO CORPORATION, Tokyo (JP)

(21) Appl. No.: 19/474,441

(22) PCT Filed: Feb. 20, 2024
(86) PCT No.: PCT/JP2024/006025

§ 371 Date: Oct. 10, 2025

(30) Foreign Application Priority Data
Apr. 14, 2023 (JP) 2023-066546

(51) Int. Cl. C02F 1/70; C02F 1/00; C02F 1/42; C02F 1/68; C02F 1/72; C02F 103/04

(52) U.S. Cl. CPC C02F 1/705; C02F 1/008; C02F 1/42; C02F 1/685; C02F 1/725; C02F 2001/422; C02F 2103/04; C02F 2209/38

(57) ABSTRACT

A water treatment device includes: a hydrogen-adding device for adding hydrogen to water being treated that contains at least hydrogen peroxide; and an oxidizing substance-removing device into which flows the water being treated to which hydrogen has been added, where the oxidizing substance-removing device includes: a catalyst device provided with a catalyst metal-supporting resin for removing hydrogen peroxide from the water being treated; a concentration-measuring means for measuring the concentration of dissolved hydrogen in the water being treated that has been treated by the catalyst device; and a control means for regulating the amount of hydrogen added by the hydrogen-adding device on the basis of the concentration of dissolved hydrogen measured by the concentration-measuring means, and where the catalyst metal-supporting resin is a platinum group metal catalyst supported on a carbonate-type anion exchange resin.

### TECHNICAL FIELD

The present invention relates to a water treatment device and a water treatment method.

### BACKGROUND ART

Ultrapure water, from which impurities have been highly removed, is used as cleaning water for electronic components, such as silicon wafers in the semiconductor manufacturing process, for example. When ultrapure water is used as cleaning water for electronic components, oxygen, hydrogen peroxide, or other oxidizing substances, if dissolved in such ultrapure water, cause the formation of natural oxides on the surfaces of electronic components.

In an ultrapure water production system, a degasser (membrane degasser, catalytic degasser, or the like) is installed, for example, in the primary pure water production apparatus or the secondary pure water production apparatus (subsystem) to lower the concentration of oxidizing substances.

When a membrane degasser is employed as such a degasser, oxidizing substances are treated by a plurality of such degassers installed in series in the primary pure water production apparatus.

As a method of removing oxygen, hydrogen peroxide, or other oxidizing substances dissolved in ultrapure water, there has been proposed a method of removing oxidizing substances by utilizing a supported platinum group metal catalyst, in which a platinum group metal, typically palladium (Pd) or platinum (Pt), is supported on a carrier (Patent Literature (PTL) 1, for example). By using a supported platinum group metal catalyst, it is possible not only to decompose and remove hydrogen peroxide through the reaction of 2H₂O₂→2H₂O+O₂ but also to remove oxygen contained in water being treated by reacting oxygen (2H₂+O₂→2H₂O) in the presence of hydrogen (H₂). Although oxygen is generated when a supported platinum group metal catalyst decomposes hydrogen peroxide, such oxygen can also be removed by reacting with hydrogen in the presence of the supported platinum group metal catalyst. Accordingly, when removing oxygen and hydrogen peroxide in water being treated by using a supported platinum group metal catalyst, such water being treated needs to contain hydrogen or is added with hydrogen as necessary.

### CITATION LIST

### Patent Literature

PTL 1: Japanese Unexamined Patent Application Publication No. 2016-215150

### SUMMARY OF INVENTION

### Technical Problem

As a carrier (ion exchanger) of a supported platinum group metal catalyst, a OH-type carrier is commonly used. However, the present inventors found, as a result of continued intensive investigation, that carbonic acid present in water being treated at a catalyst device transforms over time such a carrier (ion exchanger) into a carbonate-type to lower the removal performance of oxidizing substances, such as oxygen and hydrogen peroxide: this finding led to the present invention.

The object of the present invention is to provide a water treatment device and a water treatment method that can suppress lowering in the removal performance of oxidizing substances, such as oxygen and hydrogen peroxide, at a catalyst device, thereby attaining satisfactory quality of treated water in a stable manner.

### Solution to Problem

In order to achieve the above-mentioned object, a water treatment device of the present invention includes:
a hydrogen-adding device for adding hydrogen to water being treated that contains at least hydrogen peroxide; and
an oxidizing substance-removing device into which flows the water being treated to which hydrogen has been added by the hydrogen-adding device, where
the oxidizing substance-removing device includes:
a catalyst device provided with a catalyst metal-supporting resin for removing hydrogen peroxide from the water being treated through contact with the water being treated to which hydrogen has been added by the hydrogen-adding device;
a concentration-measuring means for measuring the concentration of dissolved hydrogen in the water being treated that has been treated by the catalyst device; and
a control means for regulating the amount of hydrogen added by the hydrogen-adding device on the basis of the concentration of dissolved hydrogen measured by the concentration-measuring means, and where
the catalyst metal-supporting resin is a catalyst metal-supporting resin in which a catalyst metal is supported on a carbonate-type anion exchange resin.

Further, a water treatment method of the present invention is directed to a water treatment method including an oxidizing substance-removing step for removing an oxidizing substance from water being treated, where
the oxidizing substance-removing step includes steps of:
adding hydrogen to the water being treated; and
allowing the water being treated to which hydrogen has been added to flow through a catalyst device provided with a catalyst metal-supporting resin, where
in the step of adding hydrogen to the water being treated, the amount of hydrogen added to the water being treated is regulated such that the concentration of dissolved hydrogen in the water being treated becomes a set value at the outlet of the catalyst device, and where
the catalyst metal-supporting resin is a catalyst metal-supporting resin in which a platinum group metal catalyst is supported on a carbonate-type anion exchange resin.

### Advantageous Effects of Invention

According to the present invention, it is possible to provide a water treatment device and a water treatment method that can suppress lowering in the removal performance of oxidizing substances, such as oxygen and hydrogen peroxide, at a catalyst device, thereby attaining satisfactory quality of treated water in a stable manner.

### BRIEF DESCRIPTION OF DRAWINGS

FIG. 1 is a schematic diagram showing an embodiment of a water treatment device of the present invention.

FIG. 2 is a schematic diagram showing an embodiment of an oxidizing substance-removing device used in the present invention.

FIG. 3 is a schematic diagram showing an embodiment of a catalyst device used in the present invention.

FIG. 4 is a flow chart of the system used in working and comparative examples.

FIG. 5 shows a graph that evaluates the correlation between H₂O₂ removal performance and the proportion of OH type in a carbonate-type anion exchange resin.

FIG. 6 shows graphs that evaluate the quality of treated water in comparison between the case in which DH concentration was regulated to become a set value at the column outlet and the case in which DO concentration was regulated to become a set value at the column outlet.

FIG. 7 shows graphs that evaluate the quality of treated water in comparison between the cases in which a catalyst metal-supporting resin is loaded in a column to the layer height of 30 cm and to the layer height of 50 cm.

FIG. 8 shows graphs that evaluate the quality of treated water in comparison among the cases in which water being treated flew into a catalyst device at varied rates LV.

### DESCRIPTION OF EMBODIMENTS

Hereinafter, the embodiments of the present invention will be described with reference to the drawings.

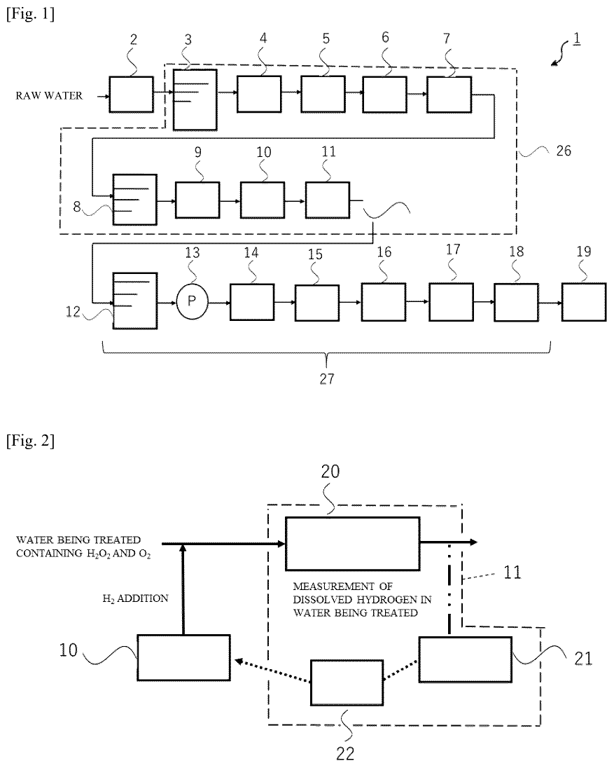

FIG. 1 is a schematic diagram showing an embodiment of a water treatment device of the present invention.

As shown in FIG. 1, a water treatment system 1 according to the present embodiment includes a pretreatment apparatus 2, a primary pure water production apparatus 26, and a subsystem 27.

The pretreatment system 2 performs pretreatment of raw water. The pretreatment system 2 includes a clarifying membrane device, for example.

The primary pure water production apparatus 26 includes a primary pure water tank 3, a cation exchange tower (K tower) 4, a decarbonation tower (D tower) 5, an anion exchange tower (A tower) 6, a reverse osmosis (RO) membrane device 7, a secondary pure water tank 8, a UV oxidation device 9, a hydrogen-adding device 10, and an oxidizing substance-removing device 11. These devices 3 to 11 are arranged in this order from upstream to downstream along the flow direction of water being treated.

The subsystem 27 includes a sub-tank 12, a pump 13, a heat exchanger 14, a UV oxidation device 15, a catalyst reaction device 16, a cartridge polisher (non-regenerative mixed bed ion exchange resin device) 17, and an ultrafiltration membrane device 18. These devices 12 to 18 are arranged in this order from upstream to downstream along the flow direction of water being treated.

The water treatment system 1 treats raw water sequentially by the pretreatment system 2, the primary pure water production apparatus 26, and the subsystem 27 to produce ultrapure water and supplies the resulting ultrapure water to a point of use 19.

Raw water is pretreated by the pretreatment apparatus 2 to produce filtered water from the raw water. The filtered water from the pretreatment apparatus 2 is supplied to the primary pure water tank 3, at which part of the filtered water is stored. From the filtered water, cationic components are removed at K tower 4, carbonic acid components are removed at D tower 5, anionic components are removed at A tower 6, and ionic impurities, nonionic organic matter, and so forth are removed at the reverse osmosis (RO) membrane device 7. The water being treated that has been subjected to the above-described treatment is then supplied to the secondary pure water tank 8, at which part of the water being treated is stored.

Subsequently, the water being treated is supplied from the secondary pure water tank 8 to the UV oxidation device 9. At the UV oxidation device 9, the water being treated is irradiated with UV to decompose organic matter therein. Upon irradiation of the water being treated with UV, hydrogen peroxide is generated. The water being treated that contains hydrogen peroxide after UV irradiation as well as dissolved oxygen is added with hydrogen by the hydrogen-adding device 10 and then supplied to the oxidizing substance-removing device 11. At the oxidizing substance-removing device 11, most of the oxidizing substances contained in the water being treated are removed. Herein, the term “oxidizing substances” encompasses hydrogen peroxide generated upon UV irradiation, dissolved oxygen originally contained in water being treated, and oxygen generated by the decomposition of hydrogen peroxide at the oxidizing substance-removing device 11. The water being treated from which most of the oxidizing substances have been removed is supplied to the subsystem 27.

In the subsystem 27, the water being treated is stored in the sub-tank 12, sent out by the pump 13, and supplied to the heat exchanger 14. The water being treated that has been subjected to temperature adjustment while passing through the heat exchanger 14 is supplied to the UV oxidation device 15 and irradiated with UV to further decompose the remaining organic matter therein. Subsequently, the water being treated is treated by, in the order of, the catalyst reaction device 16, the cartridge polisher 17, and the ultrafiltration membrane device 18. Hydrogen peroxide newly generated by the UV oxidation device 15 is removed at the catalyst reaction device 16, oxygen generated by the decomposition of hydrogen peroxide is further removed at a membrane degasser (not shown) installed as necessary, and metals and so forth are removed through ion exchange treatment at the cartridge polisher 16. Moreover, from the resulting water being treated, minute impurities are removed at the ultrafiltration membrane device 18.

The thus-obtained ultrapure water is designed such that part thereof is supplied to the point of use 19 and the remainder is sent back to the sub-tank 12.

In some cases, an ultrapure water production system is configured to lower the concentration of oxidizing substances (especially, the concentration of dissolved oxygen) in water being treated by a plurality of degassers (membrane degassers) installed in series in the primary pure water production apparatus and to supply the resulting water being treated to the subsystem 27. However, installing a plurality of membrane degassers in series increases the space necessary for the ultrapure water production system. Moreover, membrane degassers could also cause troubles, such as water leakage and component breakage. Further, degassers whose lifetime is about 5 to 10 years need to be replaced accordingly and hence are costly as well. Meanwhile, the invention according to the present embodiment uses, in the primary pure water production apparatus 26, a degasser that adds hydrogen to water being treated and utilizes a catalyst reaction, in other words, the hydrogen-adding device 10 and the oxidizing substance-removing device 11 in place of the conventional feature of a plurality of membrane degassers installed in series, thereby enabling space-saving low-cost production of ultrapure water.

In the water treatment system 1, it is possible to employ constituents commonly used in water treatment systems except for the constituents for performing the steps of removing oxidizing substances from water being treated, in other words, the hydrogen-adding device 10 for performing the step of adding hydrogen to water being treated and the oxidizing substance-removing device 11 for performing the step of allowing the water being treated to which hydrogen has been added to flow through a catalyst device provided with a catalyst metal-supporting resin. For this reason, the detailed explanation of common constituents is omitted, and the hydrogen-adding device 10 and the oxidizing substance-removing device 11 will be described hereinafter.

The hydrogen-adding device 10 adds hydrogen to water being treated. The water being treated contains dissolved oxygen in addition to hydrogen peroxide generated by UV irradiation.

The hydrogen-adding device 10 may be any device provided that hydrogen can be added to water being treated, for example, a device of the gas dissolution mode using a gas dissolving membrane or a device of the direct electrolysis mode using an electrolysis cell. In the present embodiment, it is preferable to be able to add hydrogen to water being treated in a well-responsive accurate manner. For this reason, it is preferable to employ the direct electrolysis mode that can quickly adjust the amount of hydrogen added by changing voltage applied between the electrodes.

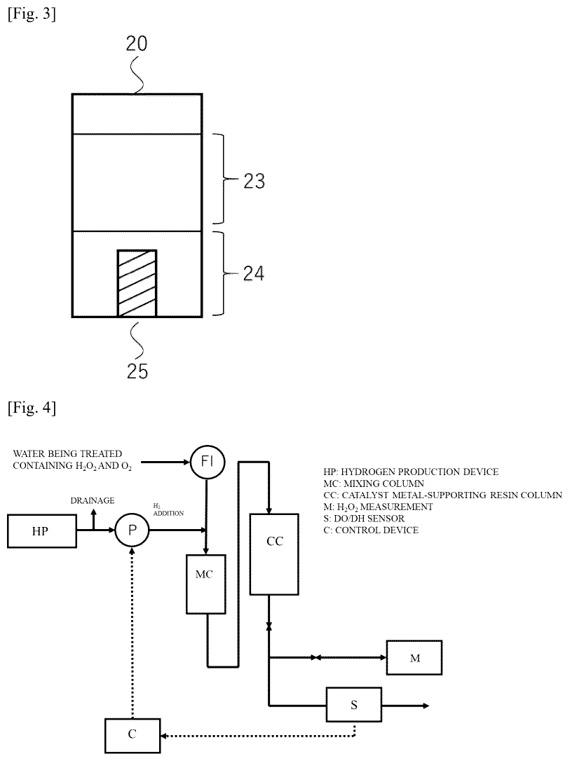

FIG. 2 is a schematic diagram showing an embodiment of the oxidizing substance-removing device 11, and FIG. 3 is a schematic diagram showing an embodiment of a catalyst device.

As shown in FIG. 2, the oxidizing substance-removing device 11 includes a catalyst device (catalyst tower) 20, a concentration-measuring means 21, and a control means 22.

In the catalyst device 20 as shown in FIG. 3, a catalyst metal-supporting resin 23 is loaded in the device (tower). On the bottom surface of the catalyst device 20, a strainer 25 is provided.

The catalyst metal-supporting resin 23 comprises a catalyst metal supported on a carrier. As the catalyst metal, a platinum group metal is used. The “platinum group metal” is a generic term for ruthenium (Ru), rhodium (Rh), palladium (Pd), osmium (Os), iridium (Ir), and platinum (Pt). In the present invention, it is preferable to use palladium or platinum and is particularly preferable to use palladium in view of the catalytic activity and so forth. As the carrier, an anion exchange resin is used in light of the preparation and reactivity of a catalyst. In the present embodiment, a carbonate-type anion exchange resin (anion exchange resin of carbonate-type as the resin type) is used. When water being treated contains carbonic acid at the oxidizing substance-removing device 11, the removal performance of oxidizing substances, such as oxygen and hydrogen peroxide, could lower, for example, since a OH-type anion exchange resin transforms over time into the carbonate-type from the OH-type as the resin type. Moreover, the replacement of such a resin due to the degradation is also inevitable. Meanwhile, the present embodiment makes it possible, by using a carbonate-type anion exchange resin, to demonstrate stable performance without being affected by the changes due to carbonic acid over time and also can use such a resin semi-permanently.

According to the results in the Examples section hereinafter, an anion exchange resin with the proportion of the OH type of 60% or less in the resin type thereof (in other words, an anion exchange resin with the proportion of the carbonate type of 40% or more in the resin type thereof) is defined as a carbonate-type anion exchange resin in the present invention.

The amount of catalyst supported is preferably 10 mg-catalyst/L-R or more and 500 mg-catalyst/L-R or less. When the amount is 10 mg-catalyst/L-R or more, peroxides can be removed sufficiently. Meanwhile, when the amount exceeds 500 mg-catalyst/L-R, increasing costs or other problems may arise in some cases.

The catalyst carrier is not particularly limited in terms of the size or the shape, and both granular and pelletized ones can be used therefor.

The catalyst metal-supporting resin 23 acts to decompose hydrogen peroxide into water and oxygen (2H₂O₂→2H₂O+O₂) through contact with water being treated that contains hydrogen peroxide. In addition, the catalyst metal-supporting resin 23 also acts to generate water (2H₂+O₂→2H₂O) by reacting hydrogen added to water being treated by the hydrogen-adding device 10, in other words, hydrogen dissolved in water being treated (dissolved hydrogen) with oxygen dissolved in the water being treated (dissolved oxygen). On this occasion, dissolved oxygen to be removed by the catalyst metal-supporting resin 23 is dissolved oxygen derived from oxygen originally dissolved in the water being treated that is supplied to the oxidizing substance-removing device 11 as well as dissolved oxygen derived from oxygen generated by the above-mentioned decomposition. Through contact of water being treated that contains hydrogen with the catalyst metal-supporting resin 23, the catalyst device 20 can thus remove oxidizing substances in the water being treated. Finally, the water being treated from which oxidizing substances have been removed by the catalyst reaction device 12 is designed to flow into the subsystem 27.

Next, the loading mode of the catalyst metal-supporting resin 23 in the catalyst device 20 will be described.

As in the foregoing, the strainer 25 is provided within the catalyst device 20. The strainer 25 plays a role of a filter that suppresses the release of resin loaded in the device (tower) into the later stages (outside the device) while allowing water being treated to flow therethrough. In the present embodiment, the strainer 25 is arranged on the bottom surface of the catalyst device 20 to cover the outlet, for water being treated, on the bottom surface of the catalyst device 20 and to project upward from the bottom surface of the catalyst device 20. In the present embodiment, the filler 24 is loaded to fill the space around the strainer 25, specifically the space between the outer surface of the strainer 25 and the inner surface of the catalyst device 20. The strainer 25 has a slit structure with a slit width of 0.5 mm or less. The resin layer in the strainer 25 portion is not used for demonstrating the performance since the contact time varies depending on flow paths. For this reason, although the catalyst device 20 may be filled with the catalyst metal-supporting resin 23 alone, filling in the stacked or mixed-bed state is preferable from a cost standpoint. In particular, as shown in FIG. 3, the stacked mode of filling the inlet side with the catalyst metal-supporting resin 23 and the outlet side (the bottom surface within the catalyst device 20) with the filler 24 is more preferable. The filler 24 for loading to bury the strainer 25 is not particularly limited unless water quality is affected, and the examples include activated carbon, gravel, beads, and ion exchange resins.

The catalyst metal-supporting resin 23 preferably has a layer height of 50 cm or more in view of the quality of treated water.

Water being treated is added with hydrogen by the hydrogen-adding device 10 at the stage before being supplied to the oxidizing substance-removing device 11. This amount of hydrogen added needs to be regulated within a certain range since the amount should be sufficient for decomposing oxidizing substances as well as not be excessive in light of the quality of ultrapure water. Meanwhile, the control method therefor is preferably simpler.

In the present embodiment, the oxidizing substance-removing device 11 is provided with the concentration-measuring means 21 at the outlet of the catalyst device 20 as a control constituent for adjusting the amount of hydrogen added by the hydrogen-adding device 10 and measures the concentration of dissolved hydrogen in water being treated. The control means 22 is configured to adjust the amount of hydrogen added by the hydrogen-adding device on the basis of the concentration of dissolved hydrogen measured by the concentration-measuring means 21. Specifically, the control means 22 preferably adjusts the amount of hydrogen added by the hydrogen-adding device 10 such that the concentration of dissolved hydrogen (DH) in water being treated at the outlet of the catalyst device 20 falls within the set value range (10 μg/L or less). By regulating the amount of hydrogen added to be more than the theoretical value, for example, it is also possible to deal with a sudden increase in the concentration of dissolved oxygen in raw water. Here, the water being treated that has been treated by the oxidizing substance-removing device 11 preferably exhibits, as the quality of treated water, a concentration of dissolved oxygen (DO) of 10 μg/L or less and a concentration of dissolved hydrogen (DH) of 10 μg/L or less.

Examples of the concentration-measuring means 21 include those by a titration method, a fluorescence method, or of a membrane electrode mode but are not limited thereto provided that dissolved oxygen and dissolved hydrogen can be measured. Among these, the membrane electrode method is preferable in terms of measurement accuracy and practicable online measurement.

It is preferable to allow water being treated to flow through the oxidizing substance-removing device 11 (catalyst device 20) at the rate of LV (linear velocity) 30 or more, in particular, LV100 or more. When the flow rate LV is slow, it takes time to reach the catalyst even if the amount of hydrogen added is changed, thereby making the control more difficult. Meanwhile, when the amount of water that can be treated by the oxidizing substance-removing device 11 (catalyst device 20) increases, it is possible to produce ultrapure water at lower costs with fewer devices needed.

According to the features described above, it is possible to provide a water treatment device and a water treatment method that enable stable removal of oxidizing substances, such as oxygen and hydrogen peroxide, at a catalyst device, thereby attaining satisfactory quality of treated water in a stable manner.

Further, ultrapure water obtained by such a water treatment device and water treatment method is high-purity ultrapure water from which organic matter, hydrogen peroxide, dissolved gasses (oxygen, etc.), ionic substances (impurities), minute particles, and so forth have been removed and hence is suitable for cleaning electronic parts as well as manufacturing equipment therefor.

### EXAMPLES

### (1) Regarding the System Used in Working and Comparative Examples

A system shown in FIG. 4 was assembled.

As a container to be filled with a catalyst metal-supporting resin, an ion exchange resin container (column) with the inner diameter of 31 mm and the height of 1 m was prepared, filled with a catalyst metal-supporting resin, and used. The catalyst metal-supporting resin from ORGANO CORPORATION was used.

A hydrogen-adding device from ORGANO CORPORATION (trade name: SAN-KAN-OH) was used.

Orbisphere 510 as a concentration-measuring device, 31230s.01 as a DH sensor, and 31120JP.01 as a DO sensor were used.

As shown in FIG. 4, a mixing column is provided to mix well added dissolved hydrogen since the convection time is short on the lab scale, but it is not necessarily needed to provide such a mixing column in the real system.

### (2) Verification of the Definition of Resin Type

Water to be treated having the concentration of dissolved oxygen (DO) of ≤10 μg/L and H₂O₂ content of 35 μg/L was prepared. Separately, a column as described above filled with a OH-type supported platinum group metal catalyst to the layer height of 10 cm was prepared. A supported platinum group metal catalyst from ORGANO CORPORATION was used.

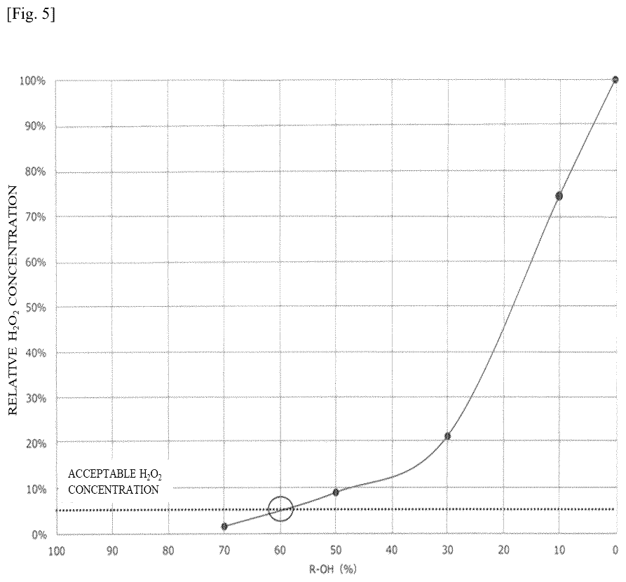

The water to be treated was allowed to flow through the column at the rate of LV425 to evaluate the correlation between H₂O₂ removal performance and the proportion of OH type after the flowing. The results are shown in FIG. 5. Since the H₂O₂ content of the treated water exceeds 1 μg/L when the proportion of OH type in the resin type becomes 60% or less as in FIG. 5, the resin at this point is defined as the carbonate type.

### (3) Comparative Evaluation of Control Methods

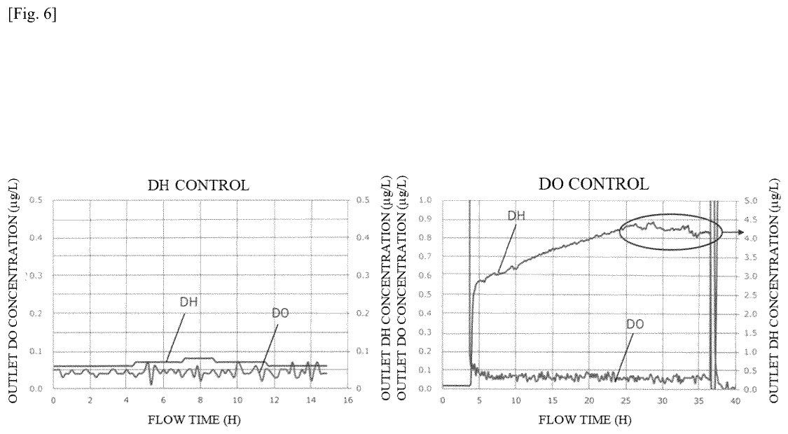

Water to be treated having the concentration of dissolved oxygen (DO) of ≤10 μg/L and H₂O₂ content of 35 μg/L was prepared. Separately, a column as described above filled with a OH-type supported platinum group metal catalyst to the layer height of 10 cm was prepared. A catalyst metal-supporting resin from ORGANO CORPORATION was used. The water to be treated was allowed to flow through the column at the rate of LV425, and the concentration of dissolved hydrogen (DH) in the treated water was compared between: the control method (hereinafter, also referred to as “DH control”) of measuring the concentration of dissolved hydrogen (DH) of the treated water from the metal catalyst-supporting resin column (water at the outlet) and regulating the amount of hydrogen added to the water to be treated at the metal catalyst-supporting resin column such that the concentration of dissolved hydrogen (DH) becomes a set value; and the control method (hereinafter, also referred to as “DO control”) of measuring the concentration of dissolved oxygen (DO) of the treated water from the metal catalyst-supporting resin column (water at the outlet) and regulating the amount of hydrogen added to the water to be treated at the metal catalyst-supporting resin column such that the concentration of dissolved oxygen (DO) becomes a set value. The results are shown in FIG. 6. As shown in FIG. 6, it was confirmed that the quality of treated water is further improved by the DH control (for regulating the amount of hydrogen added to water to be treated at the column such that the DH concentration of the treated water from the column becomes a set value) than by the DO control (for regulating the amount of hydrogen added to water to be treated at the column such that the DO concentration of the treated water from the column becomes a set value).

### (4) Evaluation of the Layer Heights of Catalyst Metal-Supporting Resin

Water to be treated having the concentration of dissolved oxygen (DO) of 2000 μg/L and H₂O₂ content of 35 μg/L was prepared. Separately, a column as described above filled with a carbonate-type supported platinum group metal catalyst to the layer height of 30 cm and the same column except for the layer height of 50 cm were prepared. A carbonate-type supported platinum group metal catalyst from ORGANO CORPORATION was used.

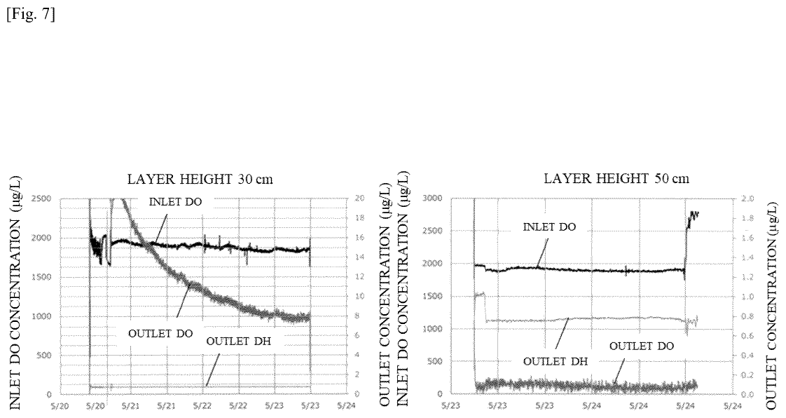

The water to be treated was allowed to flow through the respective columns with different layer heights at the rate of LV100 to evaluate the quality of the treated water due to the differences in layer height after the flowing. The results are shown in FIG. 7.

From FIG. 7, it was confirmed that the quality of the treated water is further improved in the case of setting the layer height to 50 cm than the case of setting the layer height to 30 cm.

### (5) Evaluation of Flow Rate LV of Water Being Treated

Water to be treated having the concentration of dissolved oxygen (DO) of 3500 μg/L and H₂O₂ content of 35 μg/L was prepared. Separately, a column as described above filled with a carbonate-type supported platinum group metal catalyst to the layer height of 50 cm was prepared. A carbonate-type supported platinum group metal catalyst from ORGANO CORPORATION was used.

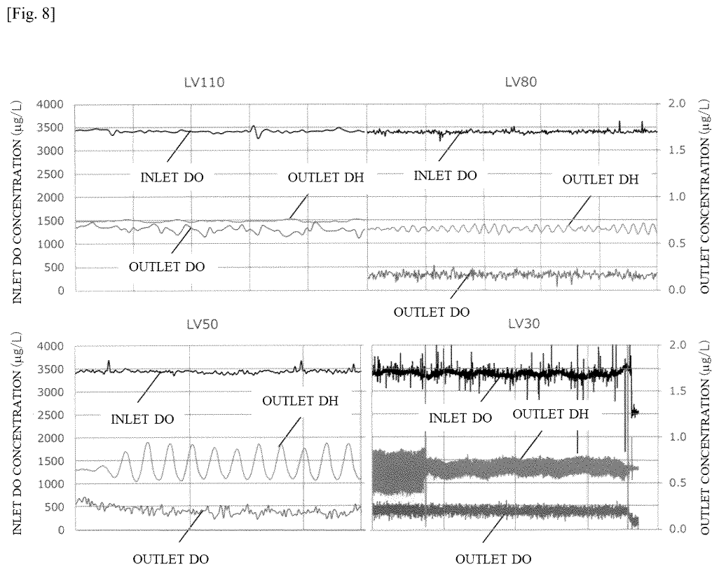

The water to be treated was allowed to flow through the column at the varied rates of LV30, 50, 80, and 110 to evaluate the quality of the treated water due to the differences in LV after the flowing. The results are shown in FIG. 8.

From FIG. 8, it was confirmed that the water quality standards (dissolved oxygen concentration of 10 μg/L or less, dissolved hydrogen concentration of 10 μg/L or less) are satisfied at any LV and that the stability in the quality of the treated water after the flowing improves as the LV increases.

As in the foregoing, the present invention is described with reference to the exemplary embodiments, but the present invention is never limited thereto. Various modifications can be made to the features and details of the present invention within the scope of the present invention that are understandable to those skilled in the art.

The present application claims priority based on Japanese Patent Application No. 2023-066546 filed on Apr. 14, 2023, the entire disclosure of which is hereby incorporated herein.

### REFERENCE SIGNS LIST

1 Water treatment system
2 Pretreatment apparatus
3 Primary pure water tank
4 K tower
5 D tower (pretreatment)
6 A tower
7 Reverse osmosis membrane device
8 Secondary pure water tank
9 UV oxidation device
10 Hydrogen-adding device
11 Oxidizing substance-removing device
12 Sub-tank
13 Pump
14 Heat exchange device
15 UV oxidation device
16 Catalyst reaction device
17 Non-regenerative mixed bed ion exchange device (cartridge polisher)
18 Ultrafiltration device
19 Point of use
20 Catalyst device
21 Concentration-measuring means
22 Control means
23 Catalyst metal-supporting resin
24 Filler
25 Strainer
26 Primary pure water production apparatus
27 Secondary pure water production apparatus (subsystem)

1. A water treatment device comprising:
a hydrogen-adding device for adding hydrogen to water being treated that contains at least hydrogen peroxide; and
an oxidizing substance-removing device into which flows the water being treated to which hydrogen has been added by the hydrogen-adding device, wherein
the oxidizing substance-removing device comprises:
a catalyst device provided with a catalyst metal-supporting resin for removing hydrogen peroxide from the water being treated through contact with the water being treated to which hydrogen has been added by the hydrogen-adding device;
a concentration-measuring means for measuring the concentration of dissolved hydrogen in the water being treated that has been treated by the catalyst device; and
a control means for regulating the amount of hydrogen added by the hydrogen-adding device on the basis of the concentration of dissolved hydrogen measured by the concentration-measuring means, and wherein
the catalyst metal-supporting resin is a catalyst metal-supporting resin in which a platinum group metal catalyst is supported on a carbonate-type anion exchange resin.

2. The water treatment device according to claim 1, wherein the control means regulates the amount of hydrogen added by the hydrogen-adding device such that the water being treated that has been treated by the oxidizing substance-removing device exhibits a concentration of dissolved hydrogen of 10 μg/L or less.

3. The water treatment device according to claim 1, wherein the catalyst metal-supporting resin is loaded in the catalyst device to a layer height of 30 cm or more.

4. The water treatment device according to claim 1, wherein the water being treated to which hydrogen has been added by the hydrogen-adding device flows into the oxidizing substance-removing device at a rate of LV30 or more.

5. The water treatment device according to claim 1, wherein the catalyst device is provided with: a strainer for suppressing the effluence of ion exchange resin that fills the catalyst device;
and a filler loaded therein to bury the strainer, and wherein the catalyst metal-supporting resin is placed on the filler.

6. The water treatment device according to claim 1, wherein the water being treated that has been treated by the oxidizing substance-removing device exhibits a concentration of dissolved oxygen of 10 μg/L or less and a concentration of dissolved hydrogen of 10 μg/L or less.

7. The water treatment device according to claim 1, wherein the water treatment device is installed in a primary pure water production apparatus of an ultrapure water production system.

8. A water treatment method comprising an oxidizing substance-removing step for removing an oxidizing substance from water being treated, wherein
the oxidizing substance-removing step comprises steps of:
adding hydrogen to the water being treated; and
allowing the water being treated to which hydrogen has been added to flow through a catalyst device provided with a catalyst metal-supporting resin, wherein
in the step of adding hydrogen to the water being treated, the amount of hydrogen added to the water being treated is regulated such that the concentration of dissolved hydrogen in the water being treated becomes a set value at the outlet of the catalyst device, and wherein
the catalyst metal-supporting resin is a catalyst metal-supporting resin in which a platinum group metal catalyst is supported on a carbonate-type anion exchange resin.
